(19) United States
(12) Patent Application Publication
(10) Pub. No.: US 2024/0239950 A1
(43) Pub. Date: Jul. 18, 2024

(54) CURABLE RESIN COMPOSITION

(71) Applicant: THREEBOND CO., LTD., Hachioji-shi, Tokyo (JP)

(72) Inventor: Naoya OTSUKI, Hachioji-shi, Tokyo (JP)

(21) Appl. No.: 18/558,786

(22) PCT Filed: May 20, 2022
(86) PCT No.: PCT/JP2022/021006

§ 371 Date: Nov. 3, 2023

(30) Foreign Application Priority Data
May 20, 2021 (JP) 2021-085076

(51) Int. Cl. C08G 59/24; C08G 59/40; C08G 59/50; C08G 61/02; C08K 3/26; C08K 3/36; C08L 33/06; C09J 11/04; C09J 133/06; C09J 163/00; C09J 165/00

(52) U.S. Cl. CPC C08G 59/245; C08G 59/4021; C08G 59/506; C08G 59/5073; C08G 61/02; C08K 3/26; C08K 3/36; C08L 33/068; C09J 11/04; C09J 133/068; C09J 163/00; C09J 165/00; C08G 2170/00; C08K 2003/265

(57) ABSTRACT

A curable resin composition containing components (A) to (E) below: (A) a compound having two or more glycidyl groups in one molecule (excluding a component (B)); (B) a glycidyl group-containing acrylic polymer; (C) a tackifier having a phenol skeleton and an OH value of 100 or more; (D) an inorganic filler; and (E) a curing agent. One embodiment of the present invention is an adhesive for structure that has high flexibility and is excellent in resin strength, adhesive strength, and toughness coefficient.

### TECHNICAL FIELD

The present invention relates to a curable resin composition for structural adhesion.

### BACKGROUND ART

In recent years, a structural adhesive may be used as a partial substitute for welding for the purpose of improving fuel consumption of automobiles and the like and reducing the weight of a vehicle body in view of low fuel consumption. In particular, an epoxy resin is widely used as a main raw material of a structural adhesive requiring high reliability because the epoxy resin exhibits excellent strength and durability due to its rigid structure.

For example, JP 2017-132953 A discloses an adhesive composition for structure that contains an epoxy resin as a main component and is excellent in adhesiveness, coating workability, and the like.

### SUMMARY OF INVENTION

### Technical Problem

From the viewpoint of weight reduction of a vehicle body, adhesion between different types of materials such as metal and plastic is required. Various stresses are applied to a vehicle body of an automobile or the like. In particular, when an adhesive is used between different types of materials, stress may be generated due to a difference in linear expansion between the different types of materials in addition to stress from the outside, and thus flexibility for alleviating the stress is also required for the adhesive itself. However, the epoxy resin that has been conventionally used as a main raw material is a material having very low flexibility due to its structure. In general, flexibility and adhesive strength of an adhesive are in a trade-off relationship, and there is a problem in that, when the adhesive strength is to be increased, the flexibility is deteriorated, and when the flexibility is to be improved, the adhesive strength is deteriorated, so that the performance as an adhesive is greatly deteriorated.

### Solution to Problem

The present inventors have conducted intensive studies in order to solve the above problems, and as a result, have found a method for obtaining a curable resin composition for suitable structural adhesion application which can improve flexibility while maintaining original excellent adhesive strength and resin strength that is strength of an adhesive itself using an epoxy resin, and has a high toughness coefficient indicating difficulty in fracture of a cured product when stress such as vibration or impact is applied. The evaluation of flexibility described in the present invention is performed by measurement of an elongation percentage (elongation at shear) based on JIS K 7161, and it is determined that when the elongation percentage is high, flexibility is high.

The gist of the present invention will be described below.
[1] A curable resin composition containing components (A) to (E) below:
   (A) a compound having two or more glycidyl groups in one molecule (excluding a component (B));
   (B) a glycidyl group-containing acrylic polymer;
   (C) a tackifier having a phenol skeleton and an OH value of 100 or more;
   (D) an inorganic filler; and
   (E) a curing agent.
[2] The curable resin composition according to [1], wherein the component (A) includes a bisphenol type epoxy resin.
[3] The curable resin composition according to [1] or [2], wherein the component (A) includes an epoxy resin having an oxyalkylene skeleton and/or a hydrogenated bisphenol type epoxy resin.
[4] The curable resin composition according to any one of [1] to [3], wherein the component (C) includes a terpene phenol resin.
[5] The curable resin composition according to any one of [1] to [4], wherein a content of the component (B) is 5 to 100 parts by mass with respect to 100 parts by mass of the component (A).
[6] The curable resin composition according to any one of [1] to [5], wherein the component (D) is one or more selected from the group consisting of wollastonite, silica, and calcium carbonate.
[7] A cured product obtained by curing the curable resin composition according to any one of [1] to [6] by heat curing.
[8] The curable resin composition according to any one of [1] to [7], wherein a toughness coefficient at 25° C. of a cured product when the curable resin composition is cured at 170° C. for 60 minutes is 10 MPa or more.
[9] The curable resin composition according to any one of [1] to [6] or [8], which is used for structural adhesion application.

### DESCRIPTION OF EMBODIMENTS

Details of the present invention will be described below. The present disclosure is not limited only to the following embodiments. In the present specification, “X to Y” is used to mean that the first and last numerical values (X and Y) are included as a lower limit value and an upper limit value, and means “X or more and Y or less”. The concentration and “%” indicate mass concentration and mass %, respectively, unless otherwise specified, and the ratio is a mass ratio unless otherwise specified. Unless otherwise specified, operations and measurements of physical properties and the like are performed under the conditions of room temperature (20 to 25° C.)/relative humidity of 40 to 55% RH. “A and/or B” is meant to include each of A and B and a combination thereof.

A curable resin composition according to an aspect of the present invention (hereinafter, also simply referred to as “composition”) contains components (A) to (E) below:
(A) a compound having two or more glycidyl groups in one molecule (excluding a component (B));
(B) a glycidyl group-containing acrylic polymer;
(C) a tackifier having a phenol skeleton and an OH value of 100 or more;
(D) an inorganic filler; and
(E) a curing agent.

By containing these components, the curable resin composition of the present invention is flexible while maintaining resin strength and adhesive strength peculiar to an epoxy resin and has a high toughness coefficient, and thus even when various stresses are applied, a cured product of the curable resin composition is hardly broken, and the curable resin composition is very useful as an adhesive for structure.

Hereinafter, each component contained in the curable resin composition will be described.

### <Component (A)>

The component (A) used in the present invention is a compound having two or more glycidyl groups in one molecule. However, a component (B) described below is not included in the component (A). The component (A) is a main component in achieving a high adhesive strength and a high resin strength as an adhesive. From the viewpoint of imparting flexibility, the component (A) is preferably a liquid at 25° C. The component (A) is not particularly limited, and specific examples thereof include an epoxy resin having an oxyalkylene skeleton, an epoxy resin having both of bisphenol and oxyalkylene skeletons, a bisphenol type epoxy resin, a hydrogenated bisphenol type epoxy resin, a naphthalene type epoxy resin, a biphenyl type epoxy resin, a phenol novolac type epoxy resin, a brominated bisphenol A type epoxy resin, a glycidylamine type epoxy resin, a dicyclopentadiene type epoxy resin, an orthocresol novolac type epoxy resin, an alicyclic epoxy resin, and the like. These may be used singly or as a mixture of two or more kinds thereof, but by combining two or more kinds thereof, the elongation percentage can be improved while the adhesive strength and the resin strength are maintained. In an embodiment, as the component (A), an epoxy resin having an oxyalkylene skeleton, an epoxy resin having both of bisphenol and oxyalkylene skeletons, a bisphenol type epoxy resin, and a hydrogenated bisphenol type epoxy resin are used in combination.

In the present invention, from the viewpoint of achieving both the elongation percentage and the resin strength, the component (A) preferably includes a bisphenol type epoxy resin having a bisphenol skeleton in one molecule. Examples of the bisphenol type epoxy resin include a bisphenol A type epoxy resin, a bisphenol F type epoxy resin, a bisphenol S type epoxy resin, a bisphenol AD type epoxy resin, and the like. Among them, from the viewpoint of achieving both the elongation percentage and the resin strength, the component (A) more preferably includes bisphenol A type diglycidyl ether and/or bisphenol F type diglycidyl ether and further preferably include bisphenol A type diglycidyl ether. An epoxy resin having both of a bisphenol skeleton and an oxyalkylene skeleton described below is not included in the bisphenol type epoxy resin.

In the present invention, when the component (A) contains an epoxy resin having an oxyalkylene skeleton and/or a hydrogenated bisphenol type epoxy resin, the elongation percentage can be further improved, which is preferable. By containing an epoxy resin having both of a bisphenol skeleton and an oxyalkylene skeleton, the resin strength and the toughness coefficient can be improved.

The epoxy resin having an oxyalkylene skeleton is a compound having a skeleton of —(R—O)— (R is an alkylene group, and the alkylene group may be linear or branched) in the main chain and having two or more epoxy groups. From the viewpoint of improving the elongation percentage, it is preferable to have a polyoxyalkylene skeleton in which the main chain is composed of a repeating unit of —(R—O)—, and from the viewpoint of curability, it is preferable that the epoxy group is at the terminal. Specific examples thereof include ethylene glycol diglycidyl ether, propylene glycol diglycidyl ether, butylene glycol diglycidyl ether, pentyl glycol diglycidyl ether, hexanediol diglycidyl ether, polyethylene glycol diglycidyl ether, polypropylene glycol diglycidyl ether, polybutylene glycol diglycidyl ether, polypentyl glycol diglycidyl ether, polytetramethylene glycol diglycidyl ether, and the like, and from the viewpoint of further improving the elongation percentage, polyethylene glycol diglycidyl ether, polypropylene glycol diglycidyl ether, and polytetramethylene glycol diglycidyl ether are preferable and polypropylene glycol diglycidyl ether is more preferable.

The hydrogenated bisphenol type epoxy resin is a compound obtained by hydrogenating an aromatic ring of a bisphenol type epoxy resin. Specific examples thereof include hydrogenated bisphenol A diglycidyl ether, hydrogenated bisphenol F diglycidyl ether, hydrogenated bisphenol B diglycidyl ether, hydrogenated bisphenol C diglycidyl ether, hydrogenated bisphenol E diglycidyl ether, hydrogenated bisphenol G diglycidyl ether, hydrogenated bisphenol M diglycidyl ether, hydrogenated bisphenol S diglycidyl ether, hydrogenated bisphenol P diglycidyl ether, hydrogenated bisphenol TMC diglycidyl ether, hydrogenated bisphenol Z diglycidyl ether, and the like, and from the viewpoint of improving the elongation percentage, hydrogenated bisphenol A diglycidyl ether and hydrogenated bisphenol F diglycidyl ether are preferable and hydrogenated bisphenol A diglycidyl ether is more preferable.

The epoxy resin having both of a bisphenol skeleton and an oxyalkylene skeleton is a compound having the above-described oxyalkylene skeleton in addition to a bisphenol skeleton in one molecule and having a glycidyl group at the terminal. By having a bisphenol skeleton and an oxyalkylene skeleton, the epoxy resin is more flexible than an epoxy resin having only a bisphenol skeleton and is more excellent in resin strength than an epoxy resin having only an oxyalkylene skeleton, and when the epoxy resin has both skeletons, a cured product excellent in fracture toughness can be obtained. Specific examples thereof include bisphenol A oxyalkylene diglycidyl ether, bisphenol F oxyalkylene diglycidyl ether, and the like, and from the viewpoint of improving the resin strength and the toughness coefficient, bisphenol A oxyalkylene diglycidyl ether is preferable, bisphenol A ethylene oxide diglycidyl ether and bisphenol A propylene oxide diglycidyl ether are more preferable, and bisphenol A propylene oxide diglycidyl ether is most preferable.

Examples of commercially available products of the bisphenol A type diglycidyl ether include, but are not limited to, jER825, jER827, 828, jER828EL, jER828US, jER828XA, and jER834 (manufactured by Mitsubishi Chemical Corporation), EPICLON 840, EPICLON 840-S, EPICLON 850, EPICLON 850-S, EPICLON EXA-850CRP, and EPICLON 850-LC (manufactured by DIC Corporation), ADEKA RESIN EP-4100, ADEKA RESIN EP-4100G, ADEKA RESIN EP-4100E, ADEKA RESIN EP-4100TX, ADEKA RESIN EP-4300E, and ADEKA RESIN EP-4400, EP-4520S, and EP-4530 (manufactured by ADEKA CORPORATION), and the like.

Examples of commercially available products of the bisphenol F type diglycidyl ether include, but are not limited to, jER806, jER806H, and jER807 (manufactured by Mitsubishi Chemical Corporation), EPICLON 830, EPICLON 830-S, EPICLON 835, EPICLON EXA-830CRP, EPICLON EXA-830LVP, and EPICLON EXA-835LV (manufactured by DIC Corporation), ADEKA RESIN EP-4901 and ADEKA RESIN EP-4901E (manufactured by ADEKA CORPORATION), and the like.

Examples of commercially available products of the epoxy resin having an oxyalkylene skeleton include, but are not limited to, EPOLIGHT M-1230, EPOLIGHT 100E, EPOLIGHT 200E, EPOLIGHT 400E, EPOLIGHT 200P, and EPOLIGHT 400P (manufactured by Kyoeisha Chemical Co., Ltd.), EPOGOSEY EN, EPOGOSEY PT, EPOGOSEY AN, EPOGOSEY 2EH, and EPOGOSEY HD, CE-EP, and S-EP (manufactured by Yokkaichi Chemical Company Limited), and the like.

Examples of commercially available products of the hydrogenated bisphenol diglycidyl ether include, but are not limited to, ST-3000 (manufactured by NIPPON STEEL Chemical Material CO., LTD.), RIKARESIN HBE-100 (manufactured by New Japan Chemical Co., Ltd.), EPOLIGHT 4000 (manufactured by Kyoeisha Chemical Co., Ltd.), jER YX8000 (manufactured by Mitsubishi Chemical Corporation), and the like.

Examples of commercially available products of the epoxy resin having both of bisphenol and oxyalkylene skeletons include EP-4000, EP-4000S, and EP-4005 (manufactured by ADEKA CORPORATION), EPOLIGHT 3002 (N) (manufactured by Kyoeisha Chemical Co., Ltd.), and the like.

From the viewpoint of maintaining the adhesive strength and improving the elongation percentage and the resin strength, the epoxy equivalent of the component (A) is preferably 100 to 500 g/eq, more preferably 130 to 400 g/eq, and most preferably 150 to 350 g/eq.

When the component (A) is composed of two or more different epoxy resins and contains a bisphenol type epoxy resin, from the viewpoint of achieving the resin strength and the elongation percentage, the content of the bisphenol type epoxy resin is preferably 1 to 60 mass %, more preferably 5 to 40 mass %, and most preferably 7 to 20 mass %, with respect to 100 mass % of the component (A).

When the component (A) is composed of two or more different epoxy resins and contains an epoxy resin having an oxyalkylene skeleton and/or a hydrogenated bisphenol type epoxy resin, from the viewpoint of improving the elongation percentage, the content of the epoxy resin having an oxyalkylene skeleton and/or the hydrogenated bisphenol type epoxy resin is preferably 10 to 90 mass %, more preferably 20 to 70 mass %, and most preferably 30 to 60 mass %, with respect to 100 mass % of the component (A).

When the component (A) is composed of two or more different epoxy resins and contains an epoxy resin having both of a bisphenol skeleton and an oxyalkylene skeleton, from the viewpoint of improving the fracture toughness, the content of the epoxy resin having both of a bisphenol skeleton and an oxyalkylene skeleton is preferably 5 to 70 mass %, more preferably 10 to 50 mass %, and most preferably 20 to 40 mass %, with respect to 100 mass % of the component (A).

### <Component (B)>

The component (B) used in the present invention is a glycidyl group-containing acrylic polymer. Since the component (B) has a glycidyl group, the component (B) with the component (A) by a component (E) can react described below, and the elongation percentage of a cured product can be dramatically improved without deteriorating the adhesive strength and the resin strength. From the viewpoint of further improving the elongation percentage, the component (B) is preferably a liquid at 25° C.

Examples of commercially available products of the component (B) include TEG-001 (manufactured by Negami Chemical Industrial Co., Ltd.), ARUFON UG-4010 (manufactured by TOAGOSEI CO., LTD.), and the like.

The weight average molecular weight of the component (B) is preferably 1000 to 100000, more preferably 1500 to 90000, and most preferably 2000 to 80000, from the viewpoint of improving the elongation percentage. The weight average molecular weight in the present invention refers to a weight average molecular weight in terms of polystyrene measured by gel permeation chromatography.

The epoxy equivalent of the component (B) is preferably 500 to 20000 g/eq, more preferably 500 to 10000 g/eq, and most preferably 600 to 8000 g/eq, from the viewpoint of improving the adhesive strength, the resin strength, and the elongation percentage. When the epoxy equivalent is 500 g/eq or more, the elongation percentage can be improved, and when the epoxy equivalent is 20000 g/eq or less, the adhesive strength and the resin strength are not deteriorated.

The content of the component (B) is preferably 5 to 100 parts by mass, more preferably 10 to 80 parts by mass, and most preferably 20 to 50 parts by mass, with respect to 100 parts by mass of the component (A). When the content is 5 parts by mass or more, the elongation percentage can be improved, and when the content is 100 parts by mass or less, there is no concern that the adhesive strength and the resin strength are deteriorated.

### <Component (C)>

The component (C) used in the present invention is a tackifier having a phenol skeleton and an OH value of 100 or more. By having a phenol skeleton, the elongation percentage can be improved without deteriorating the resin strength. When the OH value is 100 or more, compatibility with the component (A) is favorable, and a cured product having a high toughness coefficient can be obtained. From the viewpoint of maintaining the resin strength, the component (C) is preferably a solid at 25° C., and from the viewpoint of further improving the elongation percentage and the toughness coefficient, a terpene phenol resin is preferable.

The OH value of the component (C) is preferably 100 to 500, more preferably 100 to 300, and most preferably 100 to 250. When the OH value is 100 or more, compatibility with the component (A) is favorable and the toughness coefficient can be improved, and when the OH value is 500 or less, there is no concern that the resin strength is deteriorated.

The softening point of the component (C) is preferably 90° C. to 200° C., more preferably 100° C. to 180° C., and most preferably 110° C. to 160° C. When the softening point is 90° C. or higher, the resin strength is not deteriorated even in a high-temperature environment, and softening is when the point 200° C. or lower, crystallization is difficult when the component (C) is mixed with another component, so that the storage stability as the curable resin composition is not affected.

The content of the component (C) is preferably 1 to 50 parts by mass, more preferably 3 to 40 parts by mass, and most preferably 5 to 30 parts by mass, with respect to 100 parts by mass in total of the component (A) and the component (B). When the content is 1 part by mass or more, the elongation percentage and the toughness coefficient can be improved, and when the content is 50 parts by mass or less, the adhesive strength and the resin strength are not deteriorated.

Examples of commercially available products of the component (C) include YS Polyster K125, YS Polyster G125, YS Polyster N125, and YS Polyster S145 (manufactured by YASUHARA CHEMICAL CO., LTD.), TAMANOL 803L and TAMANOL 901 (manufactured by ARAKAWA CHEMICAL INDUSTRIES, LTD.), and the like.

### <Component (D)>

The component (D) that can be used in the present invention is an inorganic filler. By containing the component (D), the resin strength and the toughness coefficient can be further improved while a high elongation percentage is achieved. The component (D) is preferably a powder, and specific examples of the component (D) include minerals such as glass, silica, alumina, mica, ceramics, silicone rubber powder, calcium carbonate, calcium oxide, aluminum nitride, carbon powder, kaolin clay, wollastonite, and aluminum, and the like. The shape of the component (D) is not particularly limited, and examples thereof include a spherical shape, a needle shape, and the like. These may be used singly or as a mixture of two or more kinds thereof. Among the components (D), from the viewpoint of improving the toughness coefficient without deteriorating the flexibility and the resin strength, one or more selected from the group consisting of silica, calcium carbonate, and wollastonite are preferable.

From the viewpoint of improving the elongation percentage, the average particle size of the component (D) is preferably 0.1 to 200 μm. In the case of using calcium carbonate or silica, the average particle size is preferably 0.5 to 15 μm and further preferably 1.0 to 5 μm. In the case of using wollastonite, the average fiber diameter is preferably 1 to 20 μm and further preferably 3 to 15 μm. The average fiber length is preferably 10 to 200 μm and further preferably 30 to 100 μm. The aspect ratio is preferably 3 or more and further preferably 4 or more. Within the above range, the resin strength can be improved without deteriorating the elongation percentage. In the present invention, the average particle size, the average fiber diameter, and the average fiber length were all measured by a laser diffraction/scattering method.

The content of the component (D) is preferably 0.1 to 100 parts by mass, more preferably 1 to 70 parts by mass, and most preferably 5 to 50 parts by mass, with respect to 100 parts by mass in total of the component (A) and the component (B). When the content is 0.1 parts by mass or more, the resin strength and the toughness coefficient can be improved, and when the content is 100 parts by mass or less, the elongation 20 percentage is not deteriorated.

### <Component (E)>

The component (E) that can be used in the present invention is a curing agent. The component (E) is not particularly limited to be a liquid or a solid at 25° C. as long as it can cure the component (A) and the component (B), but from the viewpoint of the storage stability of the curable resin composition, the component (E) is preferably a solid at 25° C. and more preferably a powder. Specific examples of the component (E) include dicyandiamide, a hydrazide compound, a urea compound, an imidazole compound, a boron trifluoride-amine complex, a reaction product (adduct type latent curing agent) obtained by reacting an amine compound with an epoxy compound, an isocyanate compound, or a urea compound, and the like. Among them, from the viewpoint of the balance between the elongation percentage and the resin strength, one or more selected from the group consisting of dicyandiamide, a urea compound, and an imidazole compound are preferable. These may be used singly or as a mixture of two or more kinds thereof, but from the viewpoint of improving the fracture toughness, two or more kinds thereof are preferably mixed, and for example, a combination of dicyandiamide and an imidazole and compound a combination of dicyandiamide and a urea compound are more preferable, and a combination of three kinds of dicyandiamide, a urea compound, and an imidazole compound is most preferable.

Specific examples of the urea compound include phenyl-1,1-dimethylurea, 3-(3,4-dichlorophenyl)-1,1-dimethylurea, 3-(3-chloro-4-methylphenyl)-1,1-dimethylurea, 2,4-bis(3,3-dimethylureido) toluene, 1,1′-4 (methyl-m-phenylene)bis(3,3-dimethylurea), 4,4′-methylenebis(phenyldimethylurea), and the like.

Specific examples of the imidazole compound include 2-ethyl-4-methylimidazole, 1-benzyl-2-methylimidazole, 1-isobutyl-2-methylimidazole, 4-methyl-2-phenyl-5-hydroxymethylimidazole, and the like.

Examples of commercially available products of the dicyandiamide include jERCURE DICY7, 15, 20, and 7A (manufactured by Mitsubishi Chemical Corporation), OMICURE DDA10, DDA50, DDA100, DDA5, CG-325, DICY-F, and DICY-M (manufactured by CVC Thermoset Specialties), CG-1200 and CG-1400 (manufactured by Air Products and Chemicals, Inc.), and the like.

Examples of commercially available products of the urea compound include DCMU99 (manufactured by Hodogaya Chemical Co., Ltd.), Omicure24, Omicure52, and Omicure94 (manufactured by CVC Thermoset Specialties), and the like.

Examples of commercially available products of the imidazole compound include CUREZOL SIZ, 2MZ-H, C11Z, C17Z, 2PZ, 2PZ-PW, 2P4MZ, 2PZCNS-PW, 2MZ-A, 2MZA-PW, 2E4MZ-A, 2MA-OK, 2MAOK-PW, 2 PHZ-PW, and 2P4MHZ-PW (manufactured by SHIKOKU CHEMICALS CORPORATION), and the like.

From the viewpoint of curability, the melting point of the component (E) is preferably 150 to 300° C., more preferably 160 to 250° C., and most preferably 170 to 230° C. When the melting point is 150° C. or higher, there is no concern that the storage stability of the curable resin composition is deteriorated, and when the melting point is 300° C. or lower, there is no influence on curability, and a decrease in resin strength does not occur even when a plurality of curing agents are combined.

The blending amount of the component (E) is preferably 1 to 50 parts by mass, more preferably 3 to 20 parts by mass, and most preferably 5 to 10 parts by mass, with respect to 100 parts by mass of the total amount of the component (A) and the component (B). When the blending amount is 1 to 50 parts by mass, a cured product excellent in elongation percentage, resin strength, and fracture toughness can be obtained without deteriorating storage stability.

In the case of using a combination of dicyandiamide, a urea compound, and an imidazole compound as the component (E), from the viewpoint of improving the toughness coefficient, the ratio the content of dicyandiamide:the urea compound and/or the imidazole compound is preferably 15:1 to 2:1 and more preferably 12:1 to 3:1.

Additives such as an organic filler, a pigment, a dye, a silane coupling agent, a leveling agent, a rheology control agent, and a storage stabilizer may be further contained in an appropriate amount as long as the characteristics of the present invention are not impaired.

The organic filler may be an organic powder composed of rubber, elastomer, plastic, polymer (or copolymer), or the like. An organic filler having a multilayer structure such as a core-shell type may be used. The blending amount of the organic filler is preferably 1 to 50 parts by mass and more preferably 5 to 30 parts by mass, with respect to 100 parts by mass of the total amount of the component (A) and the component (B).

Examples of the silane coupling agent include glycidyl group-containing silane coupling agents such as 3-acryloxypropyltrimethoxysilane, 3-glycidoxypropylmethyldimethoxysilane, 3-glycidoxypropylmethyldiethoxysilane, 3-glycidoxypropylmethyldipropyloxysilane, 3-glycidoxypropyldimethylmonomethoxysilane, 3-glycidoxypropyldimethylmonoethoxysilane, 3-glycidoxypropyldimethylmonopropyloxysilane, 2-(3,4-epoxycyclohexyl)ethyltrimethoxysilane, 3-glycidoxypropyltriethoxysilane, 3-glycidoxypropyltrimethoxysilane, and 3-glycidoxypropylmethyldiethoxysilane; vinyl group-containing silane coupling agents such as vinyltris(β-methoxyethoxy) silane, vinyltriethoxysilane, and vinyltrimethoxysilane; (meth)acrylic group-containing silane coupling agents such as 3-methacryloxypropylmethyldimethoxysilane, 3-methacryloxypropylmethyldiethoxysilane, 3-methacryloxypropyldimethylmonomethoxysilane, 3-methacryloxypropyldimethylmonoethoxysilane, 3-acryloxypropylmethyldipropyloxysilane, 3-acryloxypropylmethyldimethoxysilane, 3-acryloxypropylmethyldiethoxysilane, 3-acryloxypropylmethyldipropyloxysilane, 3-acryloxypropyldimethylmonopropyloxysilane, 3-acryloxypropyldimethylmonomethoxysilane, 3-acryloxypropyldimethylmonoethoxysilane, 3-acryloxypropyldimethylmonopropyloxysilane, and Y-methacryloxypropyltrimethoxysilane; amino group-containing silane coupling agents such as N-β-(aminoethyl)-γ-aminopropyltrimethoxysilane, γ-aminopropyltriethoxysilane, and N-phenyl-γ-aminopropyltrimethoxysilane; γ-mercaptopropyltrimethoxysilane, γ-chloropropyltrimethoxysilane, and the like. Among them, from the viewpoint of excellent adhesive strength, a glycidyl group-containing silane coupling agent is more preferable. These may be used singly or in combination of two or more kinds thereof. The blending amount of the silane coupling agent is preferably 0.1 to 20 parts by mass with respect to 100 parts by mass of the total amount of the component (A) and the component (B) of the present invention. When the blending amount is 0.1 to 20 parts by mass, there is no concern that the characteristics of the present invention are impaired.

As the storage stabilizer, boric acid ester, phosphoric acid, alkyl phosphoric acid ester, or p-toluenesulfonic acid can be used. Examples of the boric acid ester include, but are not limited to, tributyl borate, trimethoxyboroxine, ethyl borate, and the like. As the alkyl phosphoric acid ester, trimethyl phosphate, tributyl phosphate, and the like can be used, but the alkyl phosphoric acid ester is not limited thereto. The storage stabilizer may be used singly or as a mixture of plural kinds thereof. In consideration of the storage stability, one or more selected from the group consisting of phosphoric acid, tributyl borate, trimethoxyboroxine, and methyl p-toluenesulfonate are preferable.

### <Coating Method>

As a method of applying the curable resin composition of the present invention to an adherend, a known sealing agent or adhesive method is used. For example, methods such as dispensing using an automatic coater, spraying, inkjet, screen printing, gravure printing, dipping, and spin coating can be used.

### <Curing Method and Cured Product>

The curable resin composition of the present invention can be cured under arbitrary heating conditions. Therefore, in an embodiment of the present invention, a cured product obtained by curing the curable resin composition by heat curing is provided. The heating temperature is not particularly limited, and is, for example, a temperature of preferably 100° C. to 300° C. and more preferably 120° C. to 200° C. The curing time is not particularly limited, and is preferably 3 minutes to 3 hours and further preferably 5 minutes or longer and 2 hours or shorter in the case of a temperature of 100° C. to 300° C.

### <Toughness Coefficient>

A cured product obtained from the curable resin composition of the present invention has an excellent toughness coefficient. The toughness coefficient indicates the resistance to fracture when mechanical stress is applied as an index, and the index of the toughness coefficient described in the present invention indicates the characteristics of toughness against fracture of a cured product. In the present invention, evaluation can be made from the measurement of the elongation percentage and the resin strength described below. As the toughness coefficient is higher, more energy is required until a cured product is broken, so that the cured product is hardly broken even when various stresses are applied. From the viewpoint of use for structural adhesion application, the toughness coefficient is preferably 10 MPa or more. The upper limit is not particularly limited, but is 30 MPa or less. In an embodiment, a toughness coefficient at 25° C. of a cured product when the curable resin composition is cured at 170° C. for 60 minutes is 10 MPa or more.

### <Use Application>

The epoxy resin composition of the present invention can be used for various use applications. Specific examples of use applications for which the curable resin composition can be used include adhesion, sealing, cast molding, coating, and the like of a vehicle body, a switch part, a head lamp, an engine internal part, an electric part, a driving engine, a brake oil tank, body panels such as a front hood, a fender, and a door, a window, and the like for automobiles; adhesion, sealing, cast molding, coating, and the like of a flat panel display (a liquid crystal display, an organic EL display, a light-emitting diode display device, or a field emission display), video disc, CD, DVD, MD, a pickup lens, hard disk in the field of electronic materials; adhesion, sealing, and the like of a lithium battery, a lithium ion battery, a manganese battery, an alkaline battery, a fuel cell, a silicon-based solar cell, dye-sensitized battery, an organic solar cell, and the like in the field of batteries; adhesion, sealing, coating, and the like of an optical switch peripheral element, an optical fiber material of optical connector periphery, an optical passive component, an optical circuit component, and an opto-electronic integrated circuit peripheral element in the field of optical components; adhesion, sealing, and the like of a camera module, a lens material, a finder prism, a target prism, a finder cover, an optical receiving sensor part, a shooting lens, a projection lens of a projection television, and the like in the field of optical apparatuses; and adhesion, lining materials, sealing materials, and the like of gas pipes, water pipes, and the like in the field of infrastructure. Among them, since the curable resin composition of the present invention has a high adhesive strength and is excellent in elongation percentage and resin strength, the curable resin composition is suitable for structural adhesion application requiring adhesive force and impact resistance.

### EXAMPLES

The present invention will be described in more detail with reference to Examples, but the present invention is not limited to only these Examples.

### Examples 1 to 7 and Comparative Examples 1 to 6

The following components were prepared in order to prepare a composition.
(a-1) Diglycidyl ether having bisphenol A and propylene oxide skeletons trade name: ADEKA RESIN EP-4000 manufactured by ADEKA CORPORATION, epoxy equivalent: 320 g/eq
(a-2) Polypropylene glycol diglycidyl ether trade name: EPOLIGHT 400P manufactured by Kyoeisha Chemical Co., Ltd., epoxy equivalent: 315 g/eq
(a-3) Bisphenol A diglycidyl ether trade name: jER828 manufactured by Mitsubishi Chemical Corporation, epoxy equivalent: 190 g/eq
(a-4) Hydrogenated bisphenol A diglycidyl ether trade name: EPOLIGHT 4000 manufactured by Kyoeisha Chemical Co., Ltd., epoxy equivalent: 230 g/eq
(b-1) Glycidyl group-containing acrylic polymer trade name: TEG-001 manufactured by Negami Chemical Industrial Co., Ltd., weight average molecular weight: 60000, epoxy equivalent: 7480 g/eq
(b-2) Glycidyl group-containing acrylic polymer trade name: ARUFON UG-4010 manufactured by TOAGOSEI CO., LTD., weight average molecular weight: 2900, epoxy equivalent: 714 g/eq
(b′-1) Glycidyl group-free core-shell acrylic particles trade name: ZEFIAC F351G manufactured by Aica Kogyo Company, Limited
(c-1) Terpene phenol resin (solid) trade name: YS Polyster K125 manufactured by YASUHARA CHEMICAL CO., LTD., OH value: 210, softening point: 125° C.
(c-2) Terpene phenol resin (solid) trade name: YS Polyster $145 manufactured by YASUHARA CHEMICAL CO., LTD., OH value: 115, softening point: 145° C.
(c-3) Terpene phenol resin (solid) trade name: YS Polyster G125 manufactured by YASUHARA CHEMICAL CO., LTD., OH value: 140, softening point: 125° C.
(c-4) Terpene phenol resin (solid) trade name: YS Polyster N125 manufactured by YASUHARA CHEMICAL CO., LTD., OH value: 165, softening point: 125° C.
(c′-1) Terpene phenol resin (solid) trade name: YS Polyster T80 manufactured by YASUHARA CHEMICAL CO., LTD., OH value: 70, softening point: 80° C.
(c′-2) Aromatically modified polyterpene (solid) trade name: YS Resin TO85 manufactured by YASUHARA CHEMICAL CO., LTD., OH value: none, softening point: 85° C.
(c′-3) Low-polymerized terpene (liquid) trade name: Daimaron manufactured by YASUHARA CHEMICAL CO., LTD., OH value: none
(c′-4) Modified terpene (liquid) trade name: YS Resin CP manufactured by YASUHARA CHEMICAL CO., LTD., OH value: none
(d-1) Wollastonite trade name: NYADM325 manufactured by Imerys S.A., average fiber diameter: 14 μm, average fiber length: 56 μm, aspect ratio: 4
(d-2) Silica trade name: AAF-04-03 manufactured by TATSUMORI LTD., average particle size: 3.7 μm
(d-3) Calcium carbonate trade name: SOFTON1800 manufactured by Shiraishi Calcium Kaisha, Ltd., average particle size: 1.3 μm
(e-1) Dicyandiamide trade name: OMICURE DDA5 manufactured by CVC Thermoset Specialties, melting point: 207 to 211° C.
(e-2) 2,4-Bis(3,3-dimethylureido) toluene trade name: OMICURE 24 manufactured by CVC Thermoset Specialties (average particle size: unknown), melting point: 180 to 195° C.
(e-3) 4-Methyl-2-phenyl-5-hydroxymethylimidazole trade name: 2P4MHZ-PW manufactured by SHIKOKU CHEMICALS CORPORATION, melting point: 191° C.

The component (A) and the component (B) were weighed in a stirring container and stirred with a mixer for 30 minutes. The component (C) was further added and the mixture was stirred for 1 hour while being heated to 150° C. After dissolution of the component (C) was confirmed, the mixture was returned to room temperature and the component (D) was added thereto and stirred for 30 minutes. Finally, the component (E) was added and the mixture was stirred for 30 minutes. The detailed preparation amounts are in accordance with Tables 1 and 2, and all numerical values are expressed in parts by mass. All tests were performed at 25° C. unless otherwise specified.

### [Elongation Percentage (Elongation at Shear)]

The curable resin composition was squeegeed on a polytetrafluoroethylene plate to have a thickness of 1.5 mm, and cured at 170° C. for 60 minutes in a hot air drying furnace, thereby obtaining a sheet-shaped cured product. The shape of No. 2 dumbbell was cut out from the sheet, and marked lines were drawn at +10 mm (interval: 20 mm) from the center in a longitudinal direction of the obtained test piece. Both ends of the test piece are fixed to a chuck of a universal tester (Autograph/manufactured by SHIMADZU CORPORATION), and a distance between the marked lines is measured with an optical non-contact measuring instrument while the test piece is pulled in a long axis direction at a speed of 50 mm/min. The test is performed until the test piece is broken.

The elongation percentage is calculated by the following equation. Details of the test are in accordance with JIS K 7161.

$$E = ( L 1 - L 0 ) / L 0 \times 100$$

E: elongation percentage (%)
L1: distance (mm) between marked lines at break
L0: distance (mm) between marked lines
Pass: 80% or more (when the elongation percentage is 80% or more, a cured product is not broken even when stress is applied, and thus it can be said that excellent flexibility is achieved).

The upper limit value is not particularly limited, but is 200% or less.

### [Resin Strength (Tensile Strength)]

The epoxy resin composition was squeegeed on a polytetrafluoroethylene plate to have a thickness of 1.5 mm, and cured at 170° C. for 60 minutes in a hot air drying furnace, thereby obtaining a sheet-shaped cured product. The cured product was punched using No. 2 dumbbell to obtain a test piece. Both ends of the test piece are fixed to a chuck of Autograph at 25° C., the test piece is pulled in a tensile direction at a tensile speed of 10 mm/min, and then a maximum load is measured. The “resin strength (MPa)” is calculated from the maximum load, and evaluation is performed based on the following evaluation criteria. Details of the test are in accordance with JIS K 6251.
Pass: 10 MPa or more, more preferably 15 MPa or more

The upper limit value is not particularly limited, but is 30 MPa or less.

### [Shear Adhesive Strength (Tensile Shear Adhesive Strength)]

The curable resin adhesive of each of Examples and Comparative Examples is applied to a test piece made of SUS304 having a size of 25 mm in width×100 mm in length×1.6 mm in thickness. Thereafter, the same test piece was bonded so that the overlapping surface was 25 mm×10 mm, fixed with a clip, and cured at 170° C. for 60 minutes in a hot air drying furnace, thereby obtaining a test piece. The shear adhesive strength (unit: MPa) is measured according to JIS K 6850 using a universal tensile tester (tensile speed: 10 mm/min) at 25° C., and evaluation is performed based on the following evaluation criteria.
Pass: 15 MPa or more

The upper limit value is not particularly limited, but is 50 MPa or less.

### [Toughness Coefficient]

The curable resin composition was squeegeed on a polytetrafluoroethylene plate to have a thickness of 1.5 mm, and cured at 170° C. for 60 minutes in a hot air drying furnace, thereby obtaining a sheet-shaped cured product. The cured product was punched using No. 2 dumbbell to obtain a test piece. Both ends of the test piece are fixed to a chuck of a universal tester (Autograph/manufactured by SHIMADZU CORPORATION), and the test piece is pulled in a tensile direction at a tensile speed of 50 mm/min and broken. A horizontal axis represents displacement (%) until breaking, a vertical axis represents stress (MPa), a perpendicular line is drawn from a breaking point to an X axis, and an area surrounded by the perpendicular line, the X axis, and SS curve is defined as a toughness coefficient. It can be said that the larger the toughness coefficient is, the more excellent the balance between the elongation percentage and the resin strength is, and the larger the energy required for fracture is, so that the curable resin composition is suitable for structural adhesion application.
Pass: 10 MPa or more

The upper limit value is not particularly limited, but is 30 MPa or less.

TABLE 1

| | | Ex- | Ex- | Ex- | Ex- | Ex- | Ex- | Ex- |
|---|---|---|---|---|---|---|---|---|
| | | ample | ample | ample | ample | ample | ample | ample |
| | | 1 | 2 | 3 | 4 | 5 | 6 | 7 |
| a-1 | ADEKA RESIN EP-4000 | 25 | 25 | 25 | 25 | 25 | 25 | 25 |
| a-2 | EPOLIGHT 400P | 25 | 25 | 25 | 25 | 25 | 25 | 25 |
| a-3 | jER828 | 12.5 | 12.5 | 12.5 | 12.5 | 12.5 | 12.5 | 12.5 |
| a-4 | EPOLIGHT 4000 | 12.5 | 12.5 | 12.5 | 12.5 | 12.5 | 12.5 | 12.5 |
| b-1 | TEG-001 | 25 | | 25 | 25 | 25 | 25 | 25 |
| b-2 | ARUFON UG-4010 | | 25 | | | | | |
| b′-1 | F351G | | | | | | | |
| c-1 | YS Polyster K125 | 15 | 15 | | | | 15 | 15 |
| c-2 | YS Polyster S145 | | | 15 | | | | |
| c-3 | YS Polyster G125 | | | | 15 | | | |
| c-4 | YS Polyster N125 | | | | | 15 | | |
| c′-1 | YS Polyster T80 | | | | | | | |
| c′-2 | YS Resin TO85 | | | | | | | |
| c′-3 | Daimaron | | | | | | | |
| c′-4 | YS Resin CP | | | | | | | |
| d-1 | NYADM325 | 10 | 10 | 10 | 10 | 10 | | |
| d-2 | AAF-04-03 | | | | | | 10 | |
| d-3 | SOFTON1800 | | | | | | | 10 |
| e-1 | OMICURE DDA5 | 6.3 | 6.3 | 6.3 | 6.3 | 6.3 | 6.3 | 6.3 |
| e-2 | OMICURE 24 | 0.825 | 0.825 | 0.825 | 0.825 | 0.825 | 0.825 | 0.825 |
| e-3 | 2P4MHZ-PW | 0.6 | 0.6 | 0.6 | 0.6 | 0.6 | 0.6 | 0.6 |
| | | 132.7 | 132.7 | 132.7 | 132.7 | 132.7 | 132.7 | 132.7 |

| | | | | | | | |
|---|---|---|---|---|---|---|---|
| Elongation percentage (%) | 93.9 | 100.9 | 96.6 | 99.1 | 96.8 | 88.9 | 116 |
| Resin strength (MPa) | 19.5 | 18.4 | 16.5 | 18.2 | 17.8 | 18.8 | 16.5 |
| Shear adhesive strength (MPa) | 27.3 | 26.6 | 18.9 | 22.8 | 24.2 | 30.4 | 26.6 |
| Toughness coefficient (MPa) | 15.6 | 15.2 | 13.1 | 14.9 | 15.3 | 14.4 | 14.4 |

TABLE 2

| | | Com- | Com- | Com- | Com- | Com- | Com- |
|---|---|---|---|---|---|---|---|
| | | parative | parative | parative | parative | parative | parative |
| | | Ex- | Ex- | Ex- | Ex- | Ex- | Ex- |
| | | ample | ample | ample | ample | ample | ample |
| | | 1 | 2 | 3 | 4 | 5 | 6 |
| a-1 | ADEKA RESIN EP-4000 | 25 | 25 | 25 | 25 | 25 | 25 |
| a-2 | EPOLIGHT 400P | 25 | 25 | 25 | 25 | 25 | 25 |
| a-3 | jER828 | 12.5 | 12.5 | 12.5 | 12.5 | 12.5 | 12.5 |
| a-4 | EPOLIGHT 4000 | 12.5 | 12.5 | 12.5 | 12.5 | 12.5 | 12.5 |
| b-1 | TEG-001 | | 25 | 25 | 25 | 25 | 25 |
| b-2 | ARUFON UG-4010 | | | | | | |
| b′-1 | F351G | 25 | | | | | |
| c-1 | YS Polyster K125 | 15 | | | | | |
| c-2 | YS Polyster S145 | | | | | | |
| c-3 | YS Polyster G125 | | | | | | |
| c-4 | YS Polyster N125 | | | | | | |
| c′-1 | YS Polyster T80 | | 15 | | | | |
| c′-2 | YS Resin TO85 | | | 15 | | | |
| c′-3 | Daimaron | | | | 15 | | |
| c′-4 | YS Resin CP | | | | | 15 | |
| d-1 | NYADM325 | 10 | 10 | 10 | 10 | 10 | 10 |
| d-2 | AAF-04-03 | | | | | | |
| d-3 | SOFTON1800 | | | | | | |
| e-1 | OMICURE DDA5 | 6.3 | 6.3 | 6.3 | 6.3 | 6.3 | 6.3 |
| e-2 | OMICURE 24 | 0.825 | 0.825 | 0.825 | 0.825 | 0.825 | 0.825 |
| e-3 | 2P4MHZ-PW | 0.6 | 0.6 | 0.6 | 0.6 | 0.6 | 0.6 |
| | | 132.7 | 132.7 | 132.7 | 132.7 | 132.7 | 117.7 |

| | | | | | | |
|---|---|---|---|---|---|---|
| Elongation percentage (%) | 3.2 | 32.3 | — | 28.3 | 160.9 | 98.2 |
| Resin strength (MPa) | 56.3 | 9.0 | — | 6.7 | 8.0 | 13.9 |
| Shear adhesive strength (MPa) | 37.8 | 10.4 | — | 7.5 | 15.5 | 22 |
| Toughness coefficient (MPa) | 1.2 | 2.3 | — | 1.5 | 8.0 | 8.9 |

It is found that Examples 1 to 7 are excellent in elongation percentage, resin strength, shear adhesive strength, and toughness coefficient. On the other hand, in Comparative Example 1 not containing the component (B), the resin strength and the shear adhesive strength were excellent, but the elongation percentage and the toughness coefficient were remarkably low. In Comparative Example 2 using the component (C) having a low OH value, satisfactory results were not obtained in all evaluation items. In Comparative Example 3 using the component (C) not having OH, the component (C) could not be compatible with the component (A) and was separated at the time of production of the curable resin composition, so that measurement of physical properties was abandoned. Also in Comparative Examples 4 and 5 using the component (C) not having OH, the toughness coefficient was low. In Comparative Example 6 not containing the component (C), the toughness coefficient was low. From the above, by combining the components (A) to (E), a cured product having excellent elongation percentage, resin strength, shear adhesive strength, and toughness coefficient can be obtained, so that the problems of the invention of the present application can be solved.

### INDUSTRIAL APPLICABILITY

Since the curable resin composition of the present invention has excellent elongation percentage, resin strength, shear adhesive strength, and toughness coefficient, the curable resin composition can be applied to various fields where high durability, reliability, and flexibility are required, and is particularly very useful for structural adhesion application.

The present application is based on Japanese Patent Application No. 2021-085076 filed on May 20, 2021, the disclosure content of which is incorporated herein by reference in its entirety.

1. A curable resin composition comprising components (A) to (E) below:
(A) a compound having two or more glycidyl groups in one molecule (excluding a component (B));
(B) a glycidyl group-containing acrylic polymer;
(C) a tackifier having a phenol skeleton and an OH value of 100 or more;
(D) an inorganic filler; and
(E) a curing agent.

2. The curable resin composition according to claim 1, wherein the component (A) includes a bisphenol type epoxy resin.

3. The curable resin composition according to claim 1, wherein the component (A) includes an epoxy resin having an oxyalkylene skeleton and/or a hydrogenated bisphenol type epoxy resin.

4. The curable resin composition according to claim 1, wherein the component (C) includes a terpene phenol resin.

5. The curable resin composition according to claim 1, wherein a content of the component (B) is 5 to 100 parts by mass with respect to 100 parts by mass of the component (A).

6. The curable resin composition according to claim 1, wherein the component (D) is one or more selected from the group consisting of wollastonite, silica, and calcium carbonate.

7. A cured product obtained by curing the curable resin composition according to claim 1 by heat curing.

8. The curable resin composition according to claim 1, wherein a toughness coefficient at 25° C. of a cured product when the curable resin composition is cured at 170° C. for 60 minutes is 10 MPa or more.

9. The curable resin composition according to claim 1, which is used for structural adhesion application.
